(19) United States
(12) Patent Application Publication
(10) Pub. No.: US 2005/0122842 A1
(43) Pub. Date: Jun. 9, 2005

(54) Sunset time device

(76) Inventor: Sean Anderson Barton, Quincy, FL (US)

Correspondence Address: SEAN BARTON, 507 E. JEFFERSON ST., QUINCY, FL, 32351, US

(21) Appl. No.: 10/998,321

(22) Filed: Nov. 26, 2004

Related U.S. Application Data
(60) Provisional application No. 60/527,185, filed on Dec. 5, 2003.

(51) Int. Cl. G04B 19/26

(52) U.S. Cl. 368/17

(57) ABSTRACT

A sunset time device for determining the time of sunrise or sunset for a particular day of the year and at a particular location on the Earth has three disk members adapted to rotate about a common center. The first disk member has in its center a map of the celestial sphere with indicia thereon showing the locations of the sunrise and sunset terminators on particular days of the year and has around its circumference indicia representing the days of the year. The second disk member has in its center a transparent window containing several colored translucent areas designed to highlight some and obscure some of the sunrise and sunset terminator indicia of the first member and has around its circumference indicia representing the hours of the day and has at a point on its circumference an indicator for aligning with the day of the year indicia of the first member. The third disk member has in its center a map of the Earth with indicia thereon representing the countries, cities, rivers, oceans, meridians, and parallels for aligning with the sunrise and sunset terminator indicia of the first member and has around its circumference indicia representing the time zones of the world for aligning with the hour of the day indicia of the second member.

This application for patent is submitted by Sean Anderson Barton, resident of Quincy, Fla., citizen of the United States. This application claims benefit of Provisional Application No. 60/527,185 filed Dec. 5, 2003.

### BACKGROUND OF THE INVENTION

The present invention relates to sunset time device for manually calculating the time of sunrise or sunset for a particular place for a particular date.

Sunset time devices or sun angle calculators that can determine the time of sunrise or sunset for a particular date and for a particular place are known in the art. U.S. Pat. No. 4,551,027 to Spruck, U.S. Pat. No. 4,435,640 to Micheletto, and U.S. Pat. No. 3,971,915 to Fletcher et al. are examples of devices that are capable of such a task. However, the problem with these devices is that they are relatively complex in design or relatively complex in operation.

Therefore, there is a need in the art for a device that can quickly and accurately determine the time of sunrise or sunset for a particular place for a particular date, such that the device is not unduly complex and is relatively inexpensive to build. Such a device should be relatively simple to operate and should be able to calculate sunrise and sunset times for any day of the year for any location on Earth.

### BRIEF SUMMARY OF THE INVENTION

The sunset time device of the present invention addresses the aforementioned needs in the art. The sunset time device provides for a device that accurately calculates the time of sunrise or sunset for a particular day of the year for a particular location on Earth and is of relatively simple design and construction and is relatively easy to use.

The sunset time device is comprised of three disk members adapted to rotate about a common center. The first disk member has in its center a map of the celestial sphere with indicia thereon showing the locations of the sunrise and sunset terminators on particular days of the year and has around its circumference indicia representing the days of the year. The second disk member has in its center a transparent window containing several colored translucent areas designed to highlight some and obscure some of the sunrise and sunset terminator indicia of the first member and has around its circumference indicia representing the hours of the day and has at a point on its circumference an indicator for aligning with the day of the year indicia of the first member. The third disk member has in its center a map of the Earth with indicia thereon representing the countries, cities, rivers, oceans, meridians, and parallels for aligning with the sunrise and sunset terminator indicia of the first member and has around its circumference indicia representing the time zones of the world for aligning with the hour of the day indicia of the second member.

### BRIEF DESCRIPTION OF THE SEVERAL VIEWS OF THE DRAWING

FIG. 1 is a top elevation view of the sunset time device.

FIG. 2 is a top elevation view of the first disk member of the sunset time device.

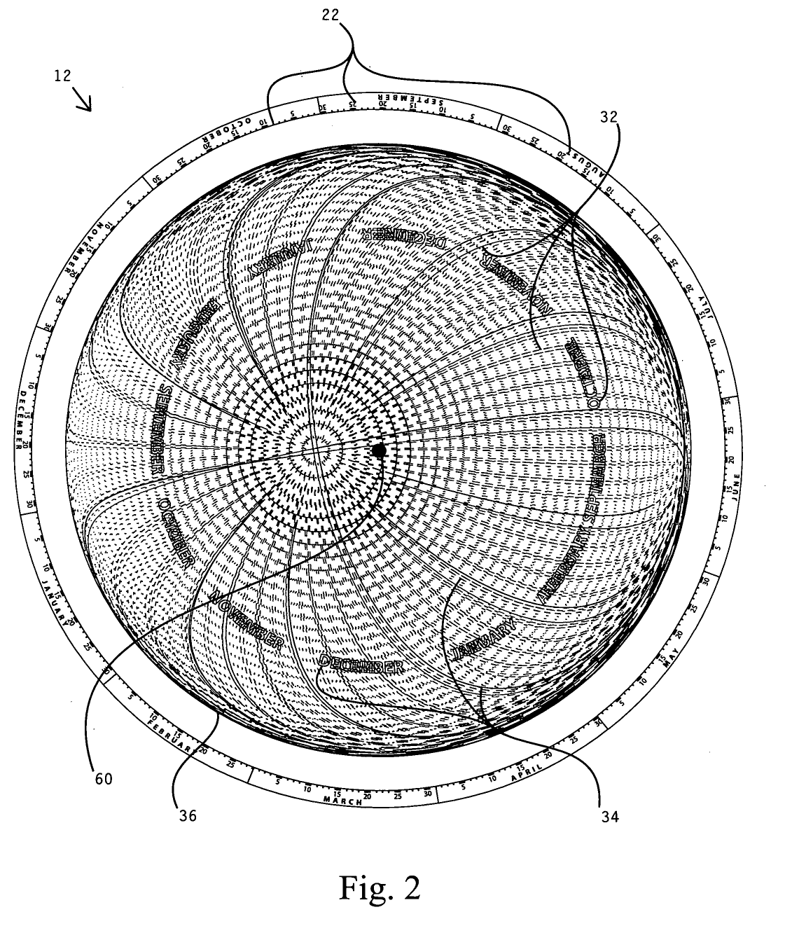

FIG. 3 is a top elevation view of the second disk member of the sunset time device.

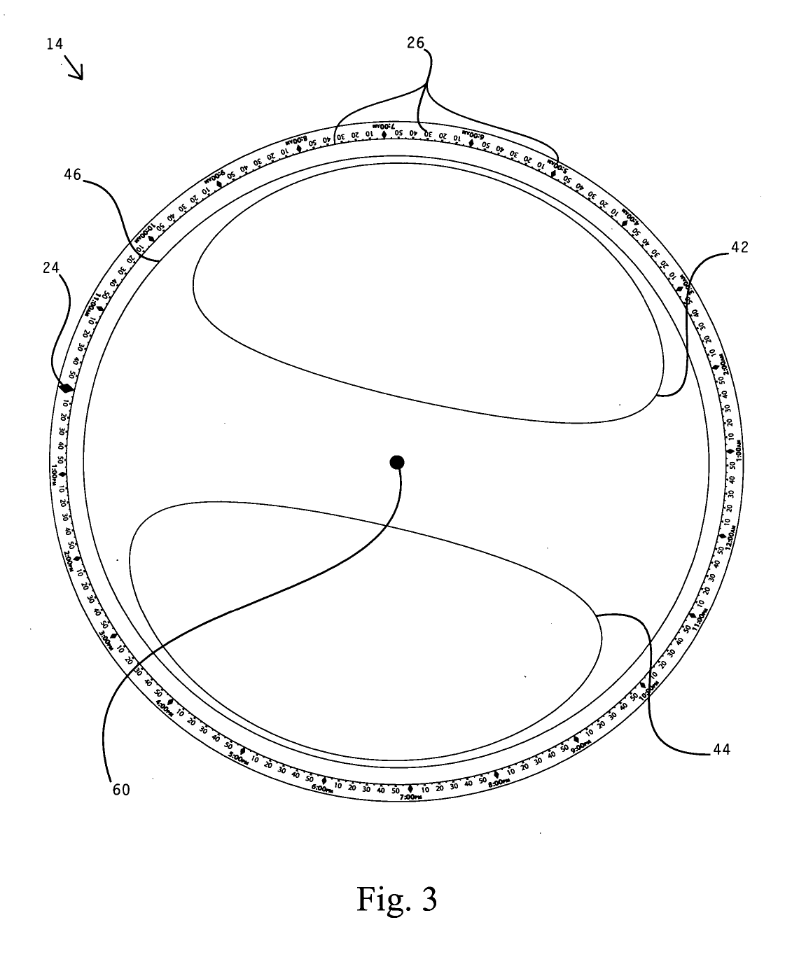

FIG. 4 is a top elevation view of the third disk member of the sunset time device.

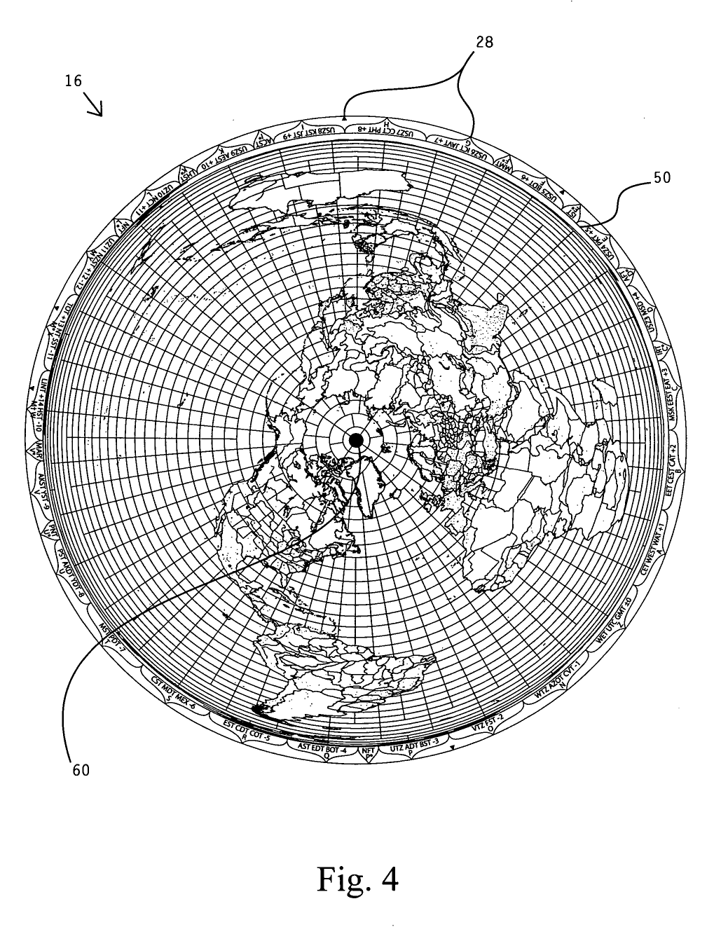

### DETAILED DESCRIPTION OF THE INVENTION

Referring now to the drawings, it is seen that the sunset time device of the present invention, generally denoted by reference numeral 10, is comprised of a first disk member 12, a second disk member 14 atop the first disk member 12, and a third disk member 16 atop the second disk member 14. The first disk member 12, the second disk member 14, and the third disk member 16 are adapted to rotate about a common center 60. As seen, each disk member 12, 14, and 16 has a generally circular shape.

As seen, the first disk member 12 has in its center a map of the celestial sphere 36 with a plurality of first indicia 32 thereon showing the location of the sunrise terminators on particular days of the year and a plurality of second indicia 34 thereon showing the location of the sunset terminators on particular days of the year and has around its circumference a plurality of third indicia 22 representing the days of the year. The second disk member 14 has in its center a transparent window 46 containing a first colored translucent area 42 and a second colored translucent area 44 and has around its circumference a plurality of forth indicia 26 representing the hours of the day and has at a point on its circumference an indicator 24 for aligning with the third indicia 22 of the first disk member. The third disk member 16 is generally transparent and has in its center a map of the Earth 50 with indicia thereon representing the countries, cities, rivers, oceans, meridians, and parallels for aligning with the first indicia 32 and second indicia 34 of the first disk member 12 and has around its circumference a plurality of fifth indicia 28 representing the time zones of the world for aligning with the forth indicia 26 of the second disk member 14.

The plurality of first indicia 32 is of a first color and the plurality of second indicia 34 is of a second color that is different from the first color. The first colored translucent area 42 is of a third color chosen to highlight the first indicia 32 and obscure the second indicia 34. The second colored translucent area 44 is of a fourth color chosen to obscure the first indicia 32 and highlight the second indicia 34.

In order to use the sunset time device 10 of the present invention, the second disk member 14 is rotated so that the indicator 24 is aligned with the third indicia 22 representing the date of interest. The third disk member 16 is then rotated so that the location on the map of the Earth 50 that is of interest is aligned with the first indicia 32 of the appropriate date to determine the time of sunrise or with the second indicia 34 of the appropriate date to determine the time of sunset. The fifth indicia 28 representing the time zones of the world are now positioned adjacent to the corresponding forth indicia 26 representing the time of day to indicate the time of day in each time zone when the event (sunrise or sunset) occurs.

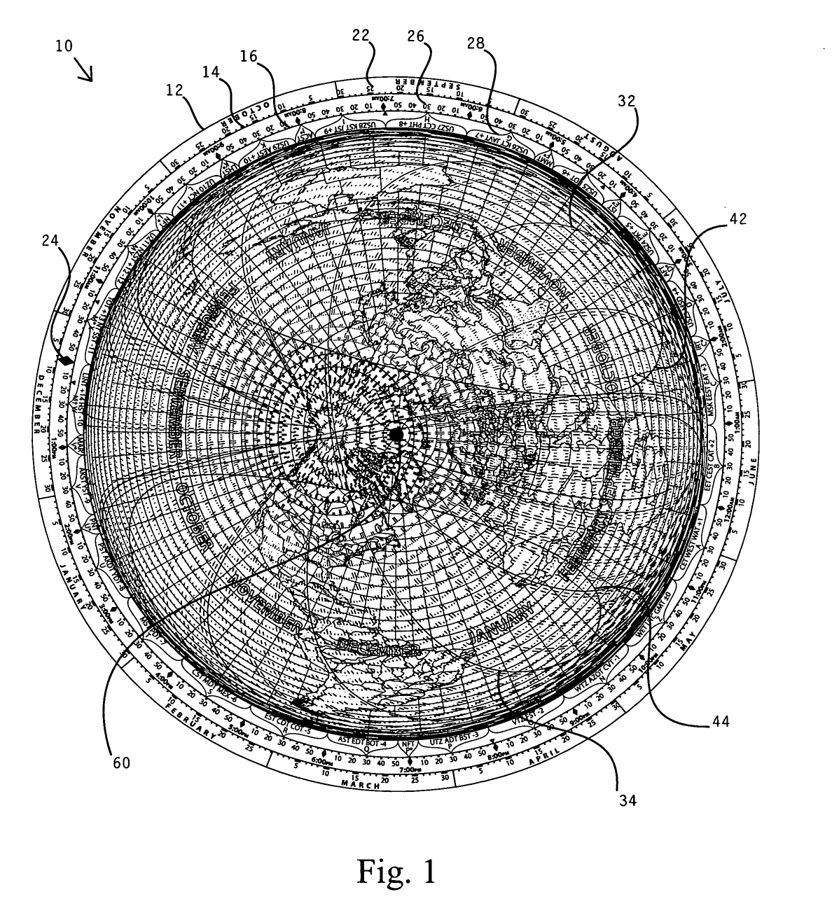

By way of example, FIG. 1, illustrates the sunset time for the date of December 8, in Atlanta, Ga.

Alternately, the sunset time device 10 may be a series of spheres instead of disks, each of the spheres operating in similar fashion to that of the disks.

While the invention has been particularly shown and described with reference to an embodiment thereof, it will be appreciated by those skilled in the art that various changes in form and detail may be made without departing from the spirit and scope of the invention.

1. A sunset time device, for determining the time of sunrise or sunset at a particular place for a particular day, comprising:
a first member of a generally circular shape having at least one center with a first plurality of day of the year indicia thereon and a circumference with a second plurality of day of the year indicia thereon;
a second member of a generally circular shape having at least one-center designed to highlight some and obscure some of the first plurality of day of the year indicia and a circumference with a plurality of time of day indicia thereon, adapted to move relative to the first member; and
a third member of a generally circular shape having at least one center with a plurality of country, city, river, ocean, meridian, and parallel indicia thereon and a circumference with a plurality of time zone indicia thereon, adapted to move relative to the second member.

2. The sunset time device as in claim 1, wherein the first member, the second member, and the third member are disks adapted to rotate about a common center.

3. The sunset time device as in claim 1, wherein the first member, the second member, and the third member are generally spheres adapted to rotate about a common center.

4. The sunset time device as in claim 2, wherein the first plurality of day of the year indicia are of several colors.

5. The sunset time device as in claim 4, wherein the center of the second member is generally transparent and contains several colored translucent areas of several colors.

6. The sunset time device as in claim 2, wherein the third member is generally transparent.
